(19) United States
(12) Patent Application Publication
(10) Pub. No.: US 2004/0200669 A1
(43) Pub. Date: Oct. 14, 2004

(54) Retractable ladder

(76) Inventors: David C. Saccente, Medford, NY (US); Bryan Kalina, Medford, NY (US)

Correspondence Address: David C. Saccente, 33 Robinson Avenue, Medford, NY, 11763, US

(21) Appl. No.: 10/769,376

(22) Filed: Feb. 2, 2004

Related U.S. Application Data
(63) Continuation of application No. 09/891,079, filed on Jun. 25, 2001, now abandoned.

(51) Int. Cl. E06C 1/00

(52) U.S. Cl. 182/204

(57) ABSTRACT

A collapsible, folding ladder that may be extended to an enhanced length for the purposes of user convenience. In a first embodiment, the ladder comprises steps on one side and typical cross braces on the other side. In a commercial mode, the ladder comprises heavy duty rungs on both sides. A lower section of concentric legs retracts from the permanently affixed legs and is held in place by two locking pins. A pin lock hole layout is located on each side of the ladder, and consists of a previously-determined quantity of apertures for insertion of spring-loaded locking pins therein. In the preferred mode, the apertures are four inches apart, allowing the user to lower the retractable section to adjust height in four inch increments. Thus, the overall height of the ladder may extend in a previously-determined range, such as from five feet to eight feet, which allows the user to reach ceilings and other high objects safely when the ladder is fully extended.

This Application is a continuation of application Ser. No. 09/891,079, filed by present Applicants.

### BACKGROUND OF THE INVENTION

1. Field of the Invention

The present invention is an improved retractable ladder. More particularly, the invention is a collapsible, folding ladder that may be extended to an enhanced length for the purposes of user convenience.

2. Description of the Prior Art

Numerous innovations for extendable or retractable ladders have been provided in the prior art that are described as follows. Even though these innovations may be suitable for the specific individual purposes to which they address, they differ from the present invention as hereinafter contrasted. The following is a summary of those prior art patents most relevant to the invention at hand, as well a description outlining the differences between the features of the present invention and those of the prior art.

1. U.S. Pat. No. 5,000,289, invented by Sanchez, entitled “Extendable Step Ladder”

The patent to Sanchez describes a folding step ladder of multipart construction that is extendable from a standard base height to a series of heights incrementally greater than the standard base height, and that is composed of four ladder elements; an upper-front element joined to an upper-rear element at a top hinge-step, a lower-front element slidingly joined to the upper-front element along its length, and a lower-rear element slidingly joined to the upper-rear element along its length. The lower elements captively slide along the length of their corresponding upper element and are capable of being held at a particular incremental extension by a latch arrangement that engages the upper element when downward force is exerted on the ladder.

2. U.S. Pat. No. 6,073,726, invented by McCrystal, entitled “Adjustable Step Ladder”

The McCrystal invention describes an adjustable step ladder having four fixed side rails which are wider apart at the bottom than at the top. The step ladder has a conventional series of steps along one side. At the bottom of each of the legs an adjustable leg is located so that the ladder can be positioned in a horizontal manner no matter how irregular the terrain upon which it stands. One or more adjustable steps are affixable to the extending legs and the adjustable steps are telescoping so that they may be made wider nearer the bottom. The result is a completely adjustable ladder which is stable because it is wider at the bottom and which may have steps which are level even though the length of the legs are uneven.

3. U.S. Pat. No. 4,989,692, invented by Min, entitled “Multi-Purpose Extendable & Retractable Ladder”

The Min invention relates to a ladder that includes two hinged sections that can be oriented in an inverted V-configuration for use as a step ladder, or in a straight linear configuration for use as a straight ladder. Each section of the ladder includes a number of U-shaped support units, each of which defines a crossbar and two downwardly extending side rails. The side rails of the different U-shaped units are of graduated cross sectional dimension, such that the units can be contracted together by telescopically sliding the aligned side rails within one another.

4. U.S. Pat. No. 6,234,273, invented by Moore, entitled “Adjustable Ladder”

The patent to Moore describes an adjustable ladder for leveling a ladder on an uneven surface. The adjustable ladder includes a ladder and leveling system. The ladder has a first leg, a second leg, and a plurality of rungs extending between the legs. A bottom end of the first leg is hollow and defines a cavity therein. An extension leg extends the length of the first leg. The extension leg comprises a housing which is slidably received in the cavity of the first leg and is adapted to selectively move inward and outward of the cavity for increasing and decreasing an effective length of the first leg. A plurality of bores are located in the first wall of the housing. Each of the bores in the first wall has a diametrically opposed and axially aligned bore in a second wall of the housing. A pin for selectively locking the housing in position is insertable through a pair of diametrically opposed bores in the first leg. The opposing bores in the housing and the first leg are aligned for inserting the pin for locking the housing.

5. U.S. Pat. No. 5,064,024, invented by Barham, entitled “Ladder Leg Extender Apparatus With Improved Vertical Adjustments Means”

In the patent to Barham, a ladder leg extender apparatus for attachment to the leg of a ladder to lengthen the leg as required to support the ladder on an uneven support surface is disclosed. The apparatus comprises a sleeve secured to a shortened leg which slidably carries an extendible support leg therein for movement inwardly and outwardly of the sleeve to adjust the length. Infinitely variable vertical adjustment of the support leg is achieved by loosening two turn bolts which secure the leg between the bolts on one side and a coarse file on the other side within the sleeve and then tightening the bolts when the support leg is properly slidably adjusted with the associated ladder is in an upright and level orientation.

6. U.S. Pat. No. 5,154,257, invented by Mirles, entitled “Adjustable Ladder Apparatus”

The patent to Mirles describes a ladder apparatus including a plurality of spaced parallel ladder legs, with each ladder leg telescopingly mounting an extension leg relative to each ladder leg to accommodate uneven surface conditions. Interlocking structure is provided to secure each respective extension leg relative to a receiving cylinder relative to each ladder leg.

7. U.S. Pat. No. 5,924,523, invented by Krause, entitled “Adjustable Ladder”

The patent to Krause describes an adjustable ladder which includes a base ladder and at least one extendable ladder movably fastened on the base ladder, the extension of which ladder can be locked by a locking bracket pivotally fastened on the extendable ladder. Locking is operated by a cable line running over guide rollers that are fixed on the base ladder. The guide rollers are arranged on the base ladder below a rung thereof and can be fastened by a first plug element serving as a mounting. The mounting can be formed of a wire or rod-shaped blank and loops around a substantial portion of the hollow section of the rung. The mounting has a bent portion extending in the direction of a rung axis and extending through a hollow tube supporting the guide roller. The bent portion is fastened to a spar of the base ladder and extends through the spar. The bent portion projects with a first end piece from an outer cheek of the spar so far that the end piece can be fixed in the direction of the rung axis.

8. U.S. Pat. No. 5,743,355, invented by McDonnell et al., entitled “Retractable Ladder”

The patent to McDonnell et al. describes a retractable ladder having a low coefficient of friction plastic bushing received within a coupling that joins a ladder rung to the associated longitudinal stile. The coupling is press fitted to the bushing, compressing a portion of the bushing against the stile, slightly deforming the adjoining portion of the stile to lock the assembly together. A latch having an inwardly sloping surface locks the ladder stiles in an extended condition and cannot be withdrawn to retract the ladder when the ladder is supporting a normal load. Dampers having orifices also are mounted in some or all of the hollow stiles to regulate the flow of air from the retracting stiles and, in this way to retard the velocity with which the ladder retracts to a predetermined, safe value.

9. U.S. Pat. No. 4,210,224, invented by Kummerlin et al., entitled “Longitudinally Variable Ladder”

The patent to Kummerlin describes a longitudinally variable ladder with at least two ladder parts which are displaceable relative to one another in their longitudinal direction, one part of which with its two struts forms a guide for the struts of the other part, which latter struts engage between the former struts, and the rungs, which are connected with the outer struts, lie on the front side of these struts, the rungs which are connected with the inner struts lying between the two planes which are defined by the front side and the rear side of these struts. The struts of all ladder parts have the same box profile, and the inner struts are guided between at least those two rungs of the outer struts which lie in the upper end section of these struts, from which upper end section the other ladder part is able to be pulled out, and guide rails, the guide rails being limited to the end section which carries the two rungs and in this end section at least indirectly engage on the rear side of the outer struts.

Although the first-above listed patent to Sanchez is similar to the present invention in concept, the Sanchez invention relies upon interlocking slide rails and locking hinges, as distinguished from spring-loaded pins. Several other aforementioned prior art patents illustrate extension ladders which fold into step ladder configurations. In addition, other prior art especially shows ladders bearing separate legs which retract to allow the ladder to be used on uneven surfaces, such as stairways.

In contrast, the present invention is a collapsible, folding ladder that may be uniformly extended in length for residential or commercial usage. An entire lower section of concentric legs retracts from permanently affixed legs and is held in place by two locking pins. A pin lock hole layout is located on each side of the ladder, and consists of multiple apertures for insertion of the locking pins, allowing the user to lower the retractable section to adjust the height of the ladder in many increments. Thus, the overall height of the ladder may extend in a range of five feet to eight feet, allowing the user to reach higher areas with a single ladder. In the fully-extended position, the device remains symmetrical, which allows for continued wide-stance stability for user safety. Therefore, the present invention is lightweight and durable, dispenses with the need for several ladders, and conserves considerable space in vehicles and storage areas.

### SUMMARY OF THE INVENTION

The present invention is an improved retractable ladder. More particularly, the invention is a collapsible, folding ladder that may be extended to an enhanced length for the purposes of user convenience.

In a first embodiment of the invention, the ladder comprises steps on one side and typical cross braces on the other side. In a commercial mode of the invention, the ladder comprises heavy duty rungs on both sides.

In both instances, a lower section of concentric legs retracts from the permanently affixed legs and is held in place by two locking pins. The locking pins may be spring-loaded and may be removable in nature, or preferably, affixed to the ladder to ensure the same are not lost by the user. A pin lock hole layout is located on each side of the ladder, and consists of a previously-determined quantity of apertures for insertion of the locking pins therein. In the preferred mode, the apertures are four inches apart from one another, allowing the user to lower the retractable section to adjust the height of the ladder in four inch increments.

Thus, the overall height of the ladder may extend in a previously-determined range, such as from five feet to eight feet, which allows the user to reach ceilings and other high objects safely when the ladder is fully extended. This is because even in the fully-extended position, the device remains symmetrical, which allows for continued wide-stance stability for user safety. Accordingly, the improved ladder complies with all relevant regulations and standards, such as those of OSHA and other authorities.

Furthermore, the ladder may be constructed of standard aluminum to accomplish its purposes at reasonable manufacturing costs. Alternatively, the ladder may be constructed of composite or other materials, such as to render the same non-conductive for utility company usage. Thus, the present invention is inexpensive to manufacture, and can even be assembled by robotic welding in several embodiments.

Moreover, additional lengths and heights of the ladder may be produced utilizing the aforementioned concept and design. It should also be noted that the ladder of the present invention may also utilize a great variety of previously-existing trays and other tool accessories, much as with traditional ladders, for enhanced user convenience.

Therefore, usage of the present invention dispenses with the need for the user to maintain several ladders of differing lengths, allowing for additional space in utility vehicles for contractors. In addition, the retractable ladder allows a sturdy and lightweight construction that is compact to easily fit in a closet or storage area.

In light of the foregoing, it is generally an object of the present invention to provide a ladder that extends to a previously determined length in a convenient manner.

It is a further object of the invention to provide a item that allows for variable lengths, as desired by the user.

It is an additional object of the invention to provide a retractable ladder that is safe to use, and is in full compliance with all relevant regulations and guidelines.

It is also an object of the invention to provide a retractable ladder for both residential and commercial usage.

It is a further object of the present invention to provide a ladder that is relatively inexpensive to manufacture, produce, and distribute.

It is an additional object of the present invention to provide a ladder that may be manufactured in a variety of sizes, so that varying versions of the same can be used for all types of activities.

In addition, it is an object of the present invention to provide a ladder that is lightweight in nature and easy for a user to transport.

It is an object of the present invention to provide a ladder that may include text or graphics thereon.

Finally, it is an object of the present invention to provide alternate embodiments of the device, wherein the invention is constructed of different materials, according to manufacturer and user needs.

The novel features which are considered characteristic for the invention are set forth in the claims. The invention itself, both as to its construction and its method of operation, together with additional objects and advantages thereof, will be best understood from the following description of the embodiments when read and understood in connection with accompanying drawings.

### BRIEF DESCRIPTION OF PREFERRED EMBODIMENTS

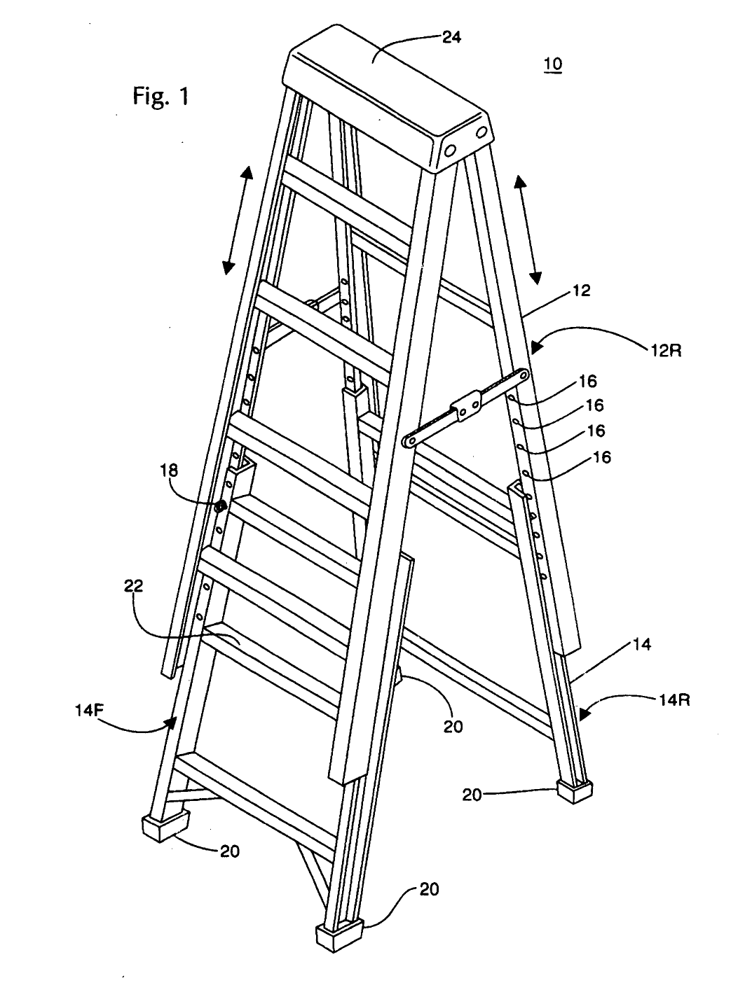

FIG. 1 is a front, three-quarter perspective view of the retractable ladder assembly of the present invention, illustrating upper section and retractable lower section thereof.

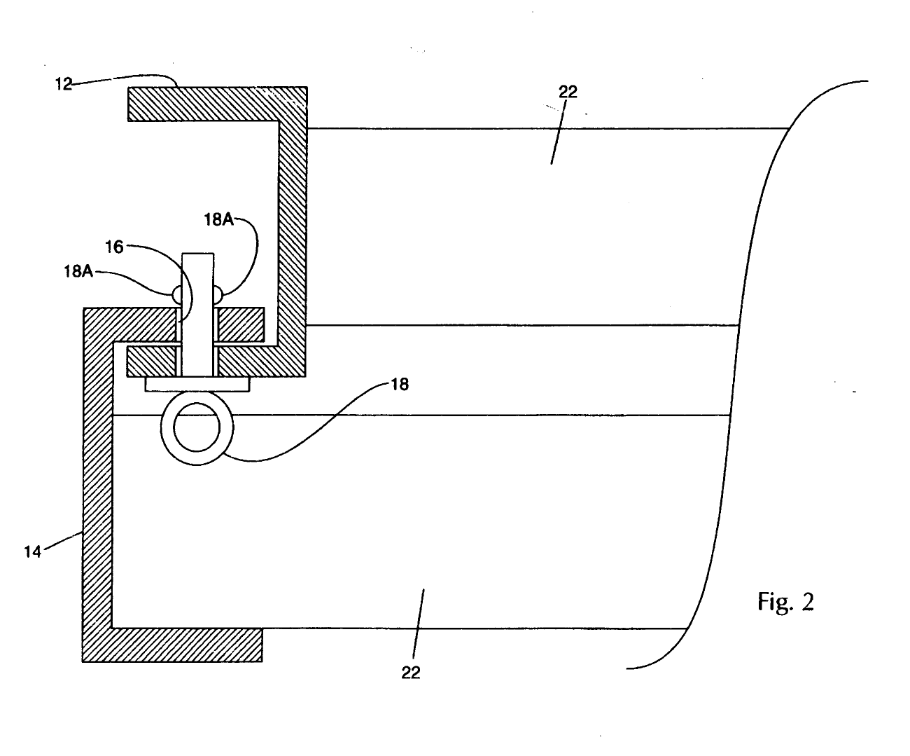

FIG. 2 is a partial cut-away view of the preferred locking mechanism utilized by the retractable ladder assembly of the present invention, illustrated for the purposes of example only.

Part Numbers: retractable ladder assembly (10), upper portion (12), upper portion front (12F), upper portion rear (12R), lower portion (14), lower portion front (14F), lower portion rear (14R), plurality of apertures (16), locking pin with pull ring (18), extended locking members (18A) plurality of legs (20), plurality of steps (22), and upper portion (24).

### DETAILED DESCRIPTION OF THE PREFERRED EMBODIMENT

Referring to FIG. 1, which is a front, three-quarter perspective view of the retractable ladder assembly of the present invention; and FIG. 2, which is a partial cut-away view of the locking mechanism utilized by the retractable ladder assembly of the present invention (for the purposes of example only):

The drawings depict retractable ladder assembly (10), upper portion (12), upper portion front (12F), upper portion rear (12R), lower portion (14), lower portion front (14F), lower portion rear (14R), plurality of apertures (16), locking pin with pull ring (18), extended locking members (18A) plurality of legs (20), plurality of steps (22), and upper portion (24).

More particularly, the retractable ladder assembly comprises an upper section (12), which comprises an upper section front portion (12F), and upper portion rear portion (12R). Next, the assembly utilizes a retractable lower section (14), which comprises a retractable lower section front portion (14F), and retractable lower section rear portion (14R).

As shown in FIG. 1, retractable lower section (14) is slidingly engaged by upper section (12), such that retractable lower section (14) may be pulled downwardly by a user to create an overall ladder of a desired height.

Importantly, a pin lock hole layout in the form of a plurality of apertures (16) is located along each side of the retractable lower section (14) and upper section (12), designed to receive a locking pin with pull ring (18) on each side. Each pull ring (18) and pin comprises extended locking members (18A) at a distal end thereof. Such functions to allow the user to align the upper and lower sections to a position of choice, and place the two spring loaded pins within the apertures of choice (16) to lock the assembly in place. As with standard ladders, a plurality of concentric legs (20) extend downwardly to engage the floor or ground surface in a stable, secure manner, regardless of whether the ladder is in extended or retracted position.

A plurality of steps (22) is located on upper section front portion (12F) and retractable lower section front portion (14F) in the residential mode of the present invention. As previously indicated, such steps (22) may also be located upon upper section rear portion (12R) and retractable lower section rear portion (14R) in commercial or industrial modes of the present invention, which remain true to the concepts and other configurations taught herein. As with standard previously existing step ladders, the present invention comprises an upper portion (24) upon which the user may place a variety of tools and implements.

Importantly, the unique ability of the present invention to extend to significantly greater heights than previously achieved dispenses with the need or desire for the user to stand atop this upper portion (24), which often has adverse consequences relating to instability of the ladder and injuries resulting therefrom.

As noted, consistent with the above theme, a first embodiment of the retractable ladder comprises a plurality of steps on a front side thereof, for the purpose of residential usage. Alternatively, a second embodiment of the retractable ladder comprises a plurality of steps on both a front side and rear side thereof, for the purpose of commercial usage.

Regarding additional versatility, the assembly may utilize a plurality of pre-fabricated steps. In addition, the assembly may further comprise a friction reducing means for the purpose of user safety. Such friction reducing means will be located in previously determined sections of the assembly, according to manufacturer and user needs.

Furthermore, the aforementioned locking pins may be affixed to the assembly via previously determined means, such that the locking pins may not be misplaced by a user. Such is of particular importance given the safety considerations of the locking pins being used correctly, at all times.

Regarding materials and methods of manufacture, the assembly may manufactured of materials such as standard aluminum or composite, depending on the applications to which the product will be directed. For the purposes of example, the assembly may also be manufactured of a non-conductive material, rendering the assembly suitable for usage by utility companies and industrial applications. In any such instance, the same may be manufactured by robotic welding, serving to greatly reduce the cost of the consumer or commercial product. Regarding same, it should also be noted that the plurality of steps may be welded in position, or, alternatively, may be riveted in position.

To provide examples of the resulting product, in one common mode of production, the ladder is of a height of five feet in its retracted position and a height of eight feet in its extended position. However, in an additional mode, the ladder is of a height of eight feet in its retracted position and a height of eleven feet in its extended position. Moreover, the ladder may be of a width in the range of twenty-four to thirty-six inches. All of the above are representative of the general capability of the present invention and additional sizes of the ladder are certainly possible.

Furthermore, the upper portion of the ladder may tapered towards the top thereof for the purpose of enhanced stability of the assembly. The assembly may also comprise diagonal cross brace members beneath each step, for the purpose of providing additional stability and support for the assembly. Therefore, in light of these and all of its characteristics, the assembly will continue to be stable and safe for users, even if the assembly is utilized upon uneven surfaces.

Regarding the ability of the user to adjust the ladder to previously determined lengths, each of the plurality of apertures is spaced four inches apart from one another in the preferred mode, providing significant versatility to both residential and commercial users.

In addition, the assembly may further comprise text, graphics, and indicia thereon. Finally, it is important to note that a great variety of tool accessories and trays may also be removably affixed to the assembly for the purpose of enhanced user convenience.

With regards to all descriptions and graphics, while the invention has been illustrated and described as embodied, it is not intended to be limited to the details shown, since it will be understood that various omissions, modifications, substitutions and changes in the forms and details of the device illustrated and in its operation can be made by those skilled in the art without departing in any way from the spirit of the invention.

Without further analysis, the foregoing will so fully reveal the gist of the present invention that others can readily adapt it for various applications without omitting features that, from the standpoint of prior art, constitute essential characteristics of the generic or specific aspects of this invention. What is claimed as new and desired to be protected by Letters Patent is set forth in the appended claims.

What is claimed is:

1. A retractable ladder assembly comprising:
upper section (12), comprising upper section front portion (12F), and upper portion rear portion (12R), the upper section (12) tapered towards the top thereof for the purpose of enhanced stability of the assembly,
retractable lower section (14), comprising retractable lower section front portion (14F), and retractable lower section rear portion (14R), retractable lower section (14) slidingly engaged by upper section (12), and able to be extended downwardly therefrom,
plurality of apertures (16) located along left and right sides of upper section (12) and left and right sides of retractable lower section (14), the apertures designed to receive locking pins with pull rings (18), comprising extended locking members (18A) at a distal end thereof, the locking pins affixed to the assembly such that the locking pins may not be misplaced by a user;
a plurality of concentric legs (20) extending downwardly to engage a floor or ground surface,
a plurality of pre-fabricated steps (22) located along at least the upper section front portion (12F) and retractable lower section front portion (14F), with diagonal cross brace members beneath each step, for the purpose of providing additional stability and support for the assembly;
a friction reducing means in at least one section of the assembly for the purpose of user safety;
and an upper portion (24) of the assembly upon which a user may place tools and implements,
the assembly functioning to allow a user to extend a collapsible, folding ladder and lock the ladder in extended position, allowing the user to reach ceilings and high areas in a safe and stable manner, from even or uneven surfaces.

2. The retractable ladder assembly as described in claim 1, wherein the retractable ladder comprises a plurality of steps on both a front side and rear side thereof, for the purpose of commercial usage.

3. The retractable ladder assembly as described in claim 1, wherein the assembly is manufactured of materials selected from the group consisting of aluminum and composite.

4. The retractable ladder assembly as described in claim 1, wherein the assembly is manufactured of a non-conductive material, rendering the assembly suitable for usage by utility companies and industrial applications.

5. The retractable ladder assembly as described in claim 1, wherein the plurality of steps are welded in position.

6. The retractable ladder assembly as described in claim 1, wherein the plurality of steps are riveted in position.

7. The retractable ladder assembly as described in claim 1, wherein the ladder is of a height of five feet in retracted position and eight feet in extended position.

8. The retractable ladder assembly as described in claim 1, wherein the ladder is of a height of eight feet in retracted position and eleven feet in extended position.

9. The retractable ladder assembly as described in claim 1, wherein the ladder is of a width in the range of twenty-four to thirty-six inches.

10. The retractable ladder assembly as described in claim 1, wherein each of the plurality of apertures is spaced four inches apart from one another.

11. The retractable ladder assembly as described in claim 1, wherein the assembly further comprises text, graphics, and indicia thereon.

12. The retractable ladder assembly as described in claim 1, wherein previously determined tool accessories and trays are removably affixed to the assembly for the purpose of enhanced user convenience.
